(19) United States
(12) Patent Application Publication
(10) Pub. No.: US 2011/0035695 A1
(43) Pub. Date: Feb. 10, 2011

(54) KEYBOARD FOR A TOUCH SCREEN

(76) Inventors: Matthew Fawcett, San Carlos, CA (US); Neil Teitelbaum, Ottawa (CA)

Correspondence Address: TEITELBAUM & MACLEAN, 280 SUNNYSIDE AVENUE, OTTAWA, ON, K1S 0R8, CA

(21) Appl. No.: 12/535,104

(22) Filed: Aug. 4, 2009

(51) Int. Cl. G06F 3/048; G06F 3/041

(52) U.S. Cl. 715/773; 345/173

(57) ABSTRACT

A tactile keyboard provides a user of a touch sensitive device having a soft keyboard with a mountable keyboard with distinct keys. The mountable keyboard can be placed directly upon the soft keyboard and facilitates typing. As the hard keys on the mountable keyboard are depressed they simultaneously depress same keys on the soft keyboard which is removably attached to the touch screen device.

### FIELD OF THE INVENTION

This invention relates to a tactile cover for an input touch keypad of a device which can lessen difficulty inputting text or data into the device.

### BACKGROUND OF THE INVENTION

Touch screens or as they are otherwise known as “soft keypads” are nearly ubiquitous, used in the cell phone industry, with mp3 players and various portable video players. Soft keypads are gaining popularity with the growth of smartphone and related devices. What all of these device have in common is a touch screen input device that is relatively small, compared to the size of a full sized typical keyboard.

Texting, or the sending of text messages on a cell phone or PDA having a touch screen requires inputting substantial amounts of data using a very small keyboard having an display which displays the alpha numeric characters, often in a QWERTY keyboard arrangement. However whether the characters are arranged alphabetically or as a QWERTY keyboard, inputting by tapping on specific small locations with essentially no tactile feedback is difficult and the process is prone to the user making errors. The lack of a tactile response also decreases input speed. All of these problems can be magnified if the user has large fingers or is unsteady or unsure of the response when inputting data.

Devices such as the Blackberry Pearl™ have a very small tactile keyboard which occupies approximately one third of the surface area of the input display side of the telephone. Although each key is a separate physical “hard” key which can be located and depressed with reasonable precision, the screen size is fixed and must be small so as to accommodate the fixed keyboard made up of distinct depressable keys on the same upper surface. Thus while providing a useful keyboard, valuable “real estate” of the upper surface is consumed reducing remaining space for the display screen.

It would be ideal however to have the benefits of a soft screen which can be changed to display alpha numeric keys in various fonts, sizes, and upper and lower case, or to display symbols in a key board arrangement while providing a distinct tactile regions to depress where the soft keys beneath, reside.

### SUMMARY OF THE INVENTION

In accordance with an aspect of this invention, a tactile cover for a device having a touch sensitive display is provided, comprising:

A substrate sized to cover at least an input alpha and or numeric soft keyboard portion of the touch sensitive display, said substrate having on a surface thereof, discrete separated contact regions each region located and sized to cover a soft key displayed beneath on the touch sensitive display when the tactile cover is placed on the device so as to provide a tactile alpha and or numeric keyboard upon the touch sensitive display.

In accordance with this invention a method is provided for converting a phone having soft keys to a phone having hard keys comprising:

Placing upon the soft keys of a touch sensitive display a plurality of depressable distinct hard keys sized to contact the soft keys.

### BRIEF DESCRIPTION OF THE DRAWINGS

Exemplary embodiments of the device will be described in accordance with the drawings, in which:

FIG. 1 is a prior art view of an ITOUCH™ wherein a user is inputting letters using a soft keyboard with two thumbs.

FIG. 2 is a photograph of a prior art ITOUCH™ or IPHONE™ displaying a soft touch sensitive keypad.

FIG. 3 is a photograph of the ITOUCH™ of FIG. 2 with a rubber keypad disposed on top of the soft keypad, in accordance with the invention.

FIG. 4 is a photograph of a standard rubber case for an ITOUCH™

### DETAILED DESCRIPTION

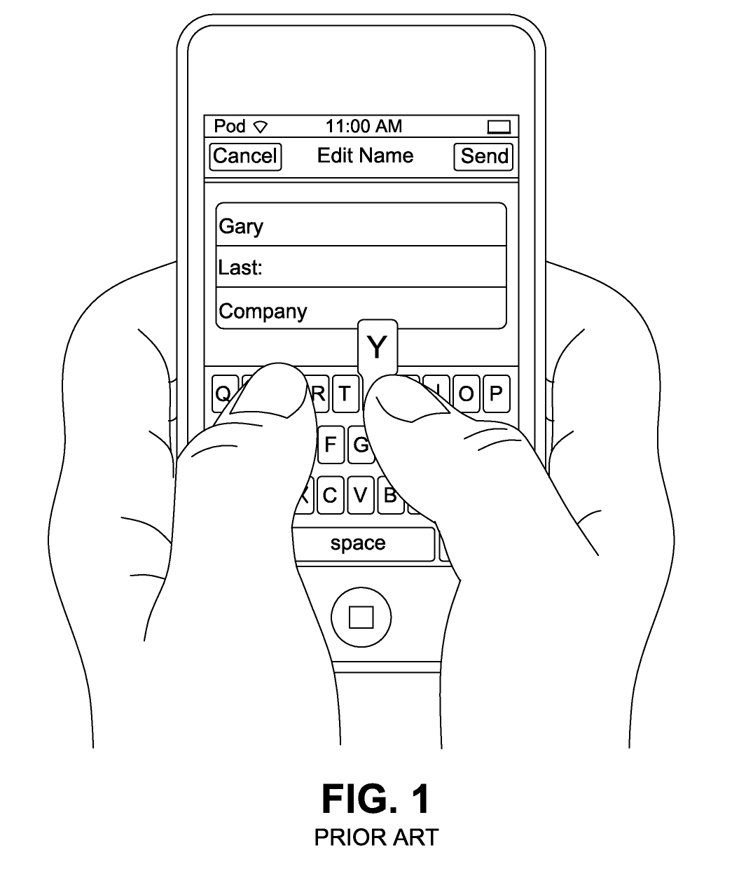

Turning now to FIG. 1 an ITOUCH™ is shown wherein a user, using two thumbs is inputting information on the touch screen. Due to the fact that there are no physical tactile boundaries on a touch screen the only feedback a user receives when typing on a touch screen is visual. This visual feedback displays the result of locating a key using a finger or thumb after input has been processed by the device. There is no tactile confirmation prior to the device processing the user's selection of a key.

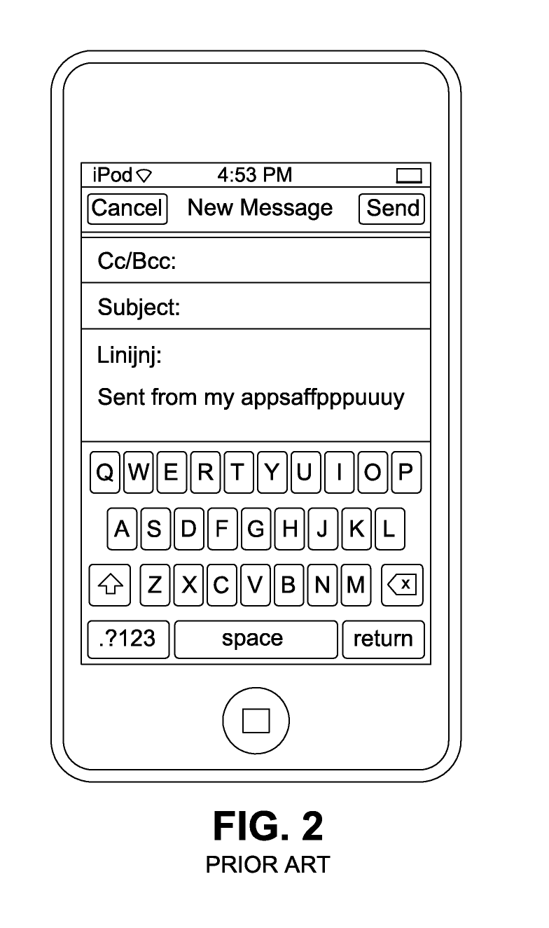

FIG. 2 shows the ITOUCH flat screen in greater detail. Of course the advantage of this type of display is that the QWERTY keyboard can be transformed into another type of keyboard or display area for photographs or videos as the user selects different modes of operation.

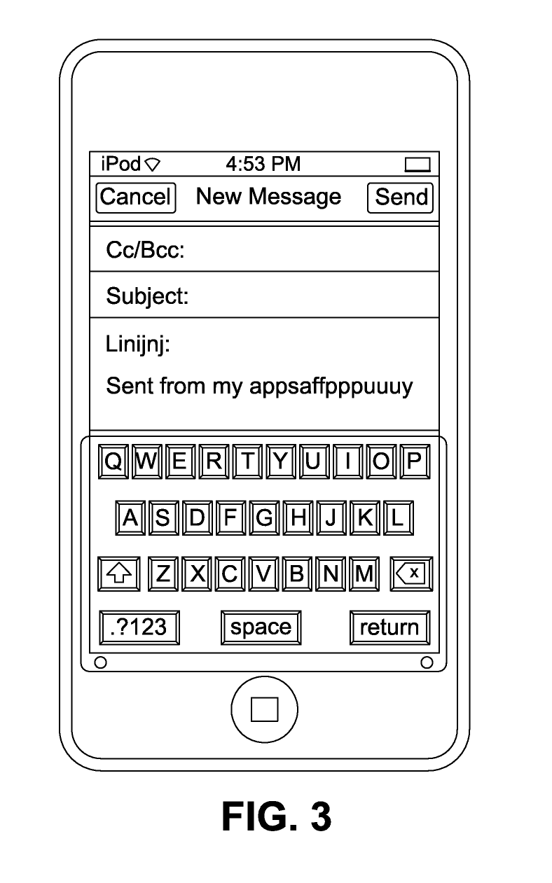

Turning now to FIG. 3, a same ITOUCH™ as shown in FIG. 2 includes a thin rubber keypad having a staggered array of raised surface regions is shown, which allows a user to type with tactile sensation so that the individual keys representing letters can be sensed. The advantage of this is that typing can be done with greater precision and pre-knowledge that a particular key is being typed. The uncertainty that occurs by hitting the boundary between two keys is lessened or obviated with this rubber keyboard.

In a preferred embodiment a material for the keyboard is used that will removably adhere to or rest upon the touch screen, however care must be taken to select a material that will respond to the user's touch through the selected material.

For example, thin rubber of the type used to make elastic bands, is suitable to work with the IPHONE™ or ITOUCH™. Silicone may be suitable for some touch sensitive displays. In a preferred embodiment small suction cups can be provided on the glass contact side to hold the keyboard in place while typing.

Rubber or silicone is currently used in the manufacture of cases for IPODs™ ITOUCH™ and IPHONE™ or other like devices. These rubber cases generally have an opening which serves as the viewing area and are otherwise closed having sides and back region formed of the same rubber or silicone. In accordance with an embodiment of this invention, a sleeve of this type is provided wherein the normally closed back region has an opening sized to the display portion of the touch screen and has a keyboard in a lower region which fits exactly over the soft keys of the device it is made for. This sleeve has two modes of operation. When a keyboard is needed the sleeve's back side becomes its front side so that the keyboard is placed over the touch screen.

When the keyboard is not required, the keyboard is placed on the back side by taking out the device and turning in around, then putting it back in the sleeve, now exposing a full opening of the touch sensitive device.

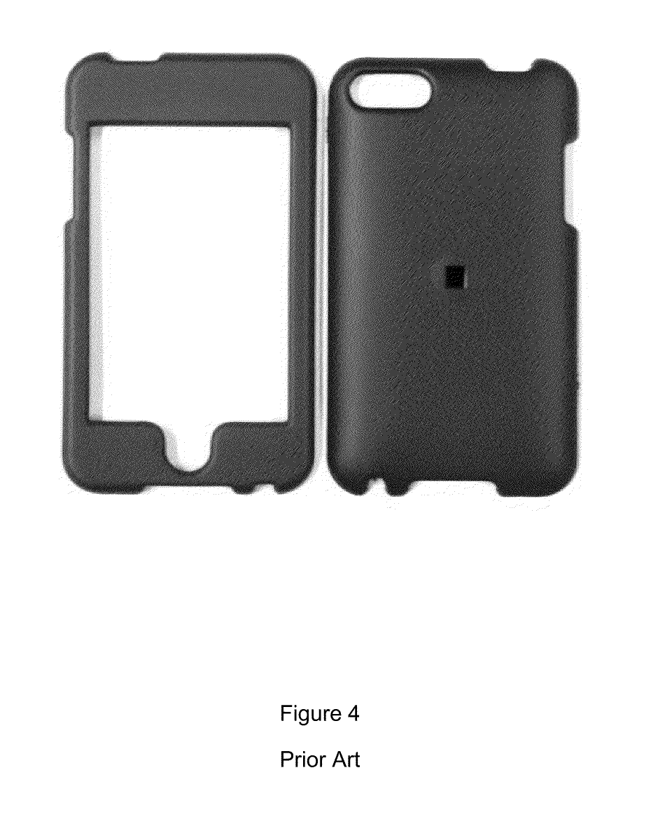

An ITOUCH™ case is shown in FIG. 4. This type of case can be modified on the back side by providing an open window sized to fit the visual part of the screen when typing and to have an integral keyboard wherein the material itself is stamped into a keyboard sized to match the keyboard on the device it houses.

Because touch screens are not standard in size, and soft keyboards vary in size and key arrangements, kits can be provided wherein the packaged preferably deformable keyboard has within or upon the package a label indicating the type of device it is manufactured for. Thus different keyboards can be manufactured for different devices.

In an embodiment not shown, the sleeve or keyboard pad may contain a chip that can be read by the device when in coupled with the device. This can serve as a confirmation that the keyboard is suitably aligned with the device and can also serve as a lock and key arrangement which enables the device when the keyboard and device are paired after authentication takes place by the device. The keyboard can also have passive identification circuitry which can be plugged into the input port of the device so at to be authenticated while in use.

In summary, this invention provides an add-on device that is useful typing on a small device having a touch screen.

What is claimed is:

1. A tactile cover for a device having a touch sensitive display comprising:
a substrate sized to cover at least an input alpha and or numeric soft keyboard portion of the touch sensitive display, said substrate having on a surface thereof, discrete separated contact regions each region located and sized to cover a soft key displayed beneath on the touch sensitive display when the tactile cover is placed on the device so as to provide a tactile alpha and or numeric keyboard upon the touch sensitive display.

2. A tactile cover as defined in claim 1, wherein the discrete separated contact regions are formed into the substrate and are integral therewith.

3. A tactile cover as defined in claim 1, wherein the substrate is at least partially transparent such that keys of the soft keyboard can be seen through the discrete separated contact regions.

4. A tactile cover as defined in claim 1, wherein the substrate has indicia on the discrete separated contact regions indicating an indicia on soft key it covers.

5. A tactile cover as defined in claim 1, wherein the substrate is a sheet of deformable material.

6. A tactile cover as defined in claim 5, wherein the sheet of deformable material is formed into a sleeve for at least partially housing the device.

7. A tactile cover as defined in claim 5, wherein the deformable material removably adheres to the touch screen upon being contacted thereon in the absence of an adhesive.

8. A tactile cover as defined in claim 5, wherein the sheet of material can adhere to the soft keypad or to the rear opposite side of the device for storage.

9. A tactile cover as defined in claim 5, wherein the contact regions each have a suction cup thereunder for adhering to the touch sensitive display.

10. A tactile cover as defined in claim 5, wherein regions of the cover have regions which more readily adhere to the touch sensitive screen than other regions for removably holding the cover in place.

11. A method is provided for converting a phone having soft keys to a phone having hard keys comprising:
placing upon the soft keys of a touch sensitive display a plurality of depressable distinct hard keys sized to contact the soft keys.

12. A method as defined in claim 11, wherein the soft keys are formed of a single sheet of deformable material.

13. A method as defined in claim 11, further comprising pressing the plurality of depressable distinct hard keys upon the touch sensitive display so as to increase contact and adhesion.

14. A method as defined in claim 11, wherein the depressible distinct hard keys are substantially transparent so as to show indicia on the soft key therethrough.

15. A kit for converting a cell phone or PDA or MP3 or video player having a touch sensitive screen, to a screen having hard keys forming a tactile distinction with other keys adjacent thereto comprising;
a deformable keypad formed of a sheet of material having keys thereon which correspond to soft keys on a device, wherein the keys can be distinguished from other keys by touch, and;
a label or indicia indicating which device the deformable keypad is to be coupled with.

16. A kit as defined in claim 15, wherein the device is an ITOUCH™, IPOD™ or IPHONE™.

17. A kit as defined in claim 15, wherein the deformable keypad is a part of a cover which envelops sides of the device and wherein the cover can be placed around the device to provide an full screen view with a keypad on the backside or wherein the cover can be placed over the touch sensitive screen so as to provide a tactile keyboard.

18. A kit as defined in claim 15, further comprising electronic means for authenticating or pairing the keyboard with the device.

19. A kit as defined in claim 15, further comprising means for authenticating the keyboard and for allowing use of the device in dependence upon the identity of the keyboard.
